(19) United States
(12) Patent Application Publication
(10) Pub. No.: US 2021/0166897 A1
(43) Pub. Date: Jun. 3, 2021

(54) KEY STRUCTURE

(71) Applicant: Silitek Electronics (Dongguan) Co., Ltd, Dongguan (CN)

(72) Inventor: Hai-Nan SHEN, Dongguan (CN)

(21) Appl. No.: 16/997,167

(22) Filed: Aug. 19, 2020

(30) Foreign Application Priority Data
Nov. 28, 2019 (CN) 201911191763.8

(51) Int. Cl. H01H 13/7065

(52) U.S. Cl. CPC H01H 13/7065

(57) ABSTRACT

A key structure includes a bottom plate, a first actuator and a keycap. The first actuator is disposed on the bottom plate and engaged with the keycap to make the keycap movably reciprocating along an actuating direction perpendicular to the bottom plate. Wherein, one of the first actuator and the keycap has a first slot; and the other one of the first actuator and the keycap has a first plug. The first plug is inserted in the first slot in parallel to the actuating direction. One of the first slot and the first plug includes at least one first protruding portion, which protrudes perpendicularly to the actuating direction and is conformally engaged with the other one of the first slot and the first plug.

This application claims the benefit of People's Republic of China application Serial No. 201911191763.8, filed Nov. 28, 2019, the subject matter of which is incorporated herein by reference.

### BACKGROUND

### Technical Field

The disclosure relates in general to a key structure, and more particularly to a key structure providing mechanical press feeling.

### Description of the Related Art

Input device is normally used as a communication interface between the user and the electronic device. The input device, such as a plurality of key structures. By pressing different keys, the user can enable the electronic device to generate corresponding actions. Of the different types of key structure, the mechanical key structure possessing the advantages of better hand touch, longer lifespan and shorter triggering course has won a great popularity over the years.

Typical mechanical key structure at least includes a keycap, a switch and a bottom plate. The keycap is disposed on the bottom plate and can movably reciprocate up and down through the switch. In detail, the keycap, limited by the switch, can movably reciprocate between the top end position and the bottom end along the vertical axis direction. When the keycap is pressed, the keycap can move to the bottom end position from the top end position and cause the switch to generate a triggering signal. Generally, the switch and the keycap are connected and tightly engaged with each other by inserting the plug disposed at the top of the switch into the slot disposed at the bottom surface of the keycap.

However, if the squeezing force generated between the plug and the slot is too large, the sidewall of the slot may be easily ruptured. On the contrary, if the squeezing force is too small, the plug may easily escape from the slot. And the balance between these two is difficult to grasp, which further enlarges the process variation and adversely affect the yield rate and the quality of the mechanical key structure.

Therefore, it has become a prominent task for the industry to provide an advanced key structure which has improved yield rate and the quality and is able to resolve the current technical problems.

### SUMMARY

According to one embodiment of the present disclosure, a key structure is provided, wherein the key structure is provided includes a bottom plate, a first actuator and a keycap. The first actuator is disposed on the bottom plate and engaged with the keycap to make the key cap movably reciprocating along an actuating direction perpendicular to the bottom plate. Wherein, one of the first actuator and the keycap has a first slot; and the other one of the first actuator and the keycap has a first plug. The first plug is inserted in the first slot in parallel to the actuating direction. One of the first slot and the first plug includes at least one first protruding portion, which protrudes perpendicularly to the actuating direction and is conformally engaged with the other one of the first slot and the first plug.

According to aforementioned embodiments of the present disclosure, a key structure is provided. The key structure comprises a keycap and an actuator. The actuator is engaged with the keycap by a plug and a slot and enables the keycap to movably reciprocate along an actuating direction. At least one protruding portion protruding outward and perpendicular to the actuating direction is provided on the sidewall of one of the plug and the slot, and the hardness of the protruding portion is greater than the hardness of the sidewall of the other one of the plug and the slot. When the plug is inserted into the slot, the protruding portion squeezes the corresponding sidewall encountering the protruding portion and forms a recess on the corresponding sidewall to conformally engage with the protruding portion. Such that sufficient interference fit can be provided to make the actuator and the keycap tightly engaged.

By this approach, it is not necessary to additionally increase the difference in width dimension between the plug and the slot in order to form a tighter interference fit there between, and the lateral squeezing force applied by the plug to the sidewall of the slot can be greatly reduced. Thereby, the bursting risk of the keycap/switch due to excessive lateral squeezing force can be effectively reduced, on the premise of achieving a proper interference fit, when the slot and the plug are engaged. The processing yield of assembling the keycap and the switch as well as the quality of the key structure can be thus improved.

The present disclosure will be described in detail with reference to the accompanying drawings and specific embodiments, but it is not intended to limit the scope of the present invention.

### BRIEF DESCRIPTION OF THE DRAWINGS

The above and other aspects of the disclosure will become better understood with regard to the following detailed description of the preferred but non-limiting embodiment (s). The following description is made with reference to the accompanying drawings.

FIG. 1A is a three-dimensional (3D) assembly diagram illustrating a key structure according to one embodiment of the disclosure;

FIG. 1B is a 3D explosion diagram illustrating of the key structure of FIG. 1A;

FIG. 1C is a partial cross-sectional view of the key structure taken along the tangent line S1 of FIG. 1A;

FIG. 2A is a 3D assembly diagram illustrating a key structure according to another embodiment of the disclosure;

FIG. 2B is a 3D explosion diagram illustrating the key structure of FIG. 2A;

FIG. 2C is an enlarged view illustrating a partial structure of a first actuator as depicted in FIG. 2A;

FIG. 2D is an enlarged view illustrating a partial structure of a second actuator as depicted in FIG. 2A;

FIG. 2E is an enlarged view illustrating a partial structure of a third actuator as depicted in FIG. 2A;

FIG. 2F is a partial cross-sectional view of a key structure taken along the tangent line S2 of FIG. 2A;

FIG. 2G is a partial cross-sectional view of the key structure taken along the tangent line S3 of FIG. 2A; and

FIG. 2H is a partial cross-sectional view of the key structure taken along the tangent line S4 of FIG. 2A.

### DETAILED DESCRIPTION

The embodiments of the present disclosure provide a key structure to resolve the problems of either a slot being easily ruptured, due to a squiring force while a plug is inserted into the slot to engage the keycap and the switch with each other, or the problems of the plug easily escaping from the slot, due to insufficient friction, so as to improve the yield and the quality of the key structure. For the object, technical features and advantages of the present invention to be more easily understood by anyone ordinary skilled in the technology field, a number of exemplary embodiments are disclosed below with detailed descriptions and accompanying drawings.

It should be noted that these embodiments are illustrative and for explanatory purposes only, not for limiting the scope of protection of the invention. The invention can be implemented by using other features, elements, methods and parameters. The preferred embodiments are merely for illustrating the technical features of the disclosure, not for limiting the scope of protection. Anyone skilled in the technology field of the disclosure will be able to make suitable modifications or changes based on the specification disclosed below without breaching the spirit of the disclosure. Designations common to the accompanying drawings are used to indicate identical or similar elements.

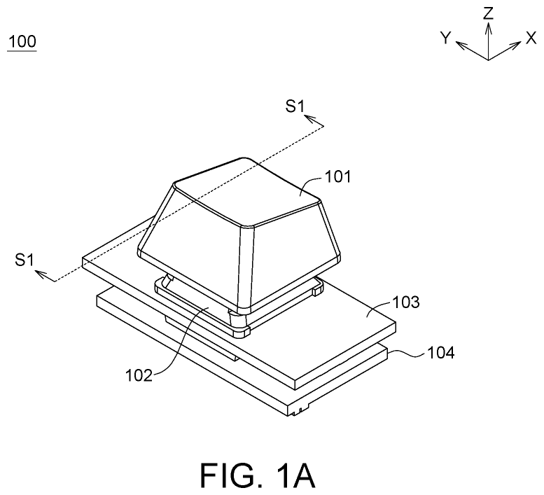

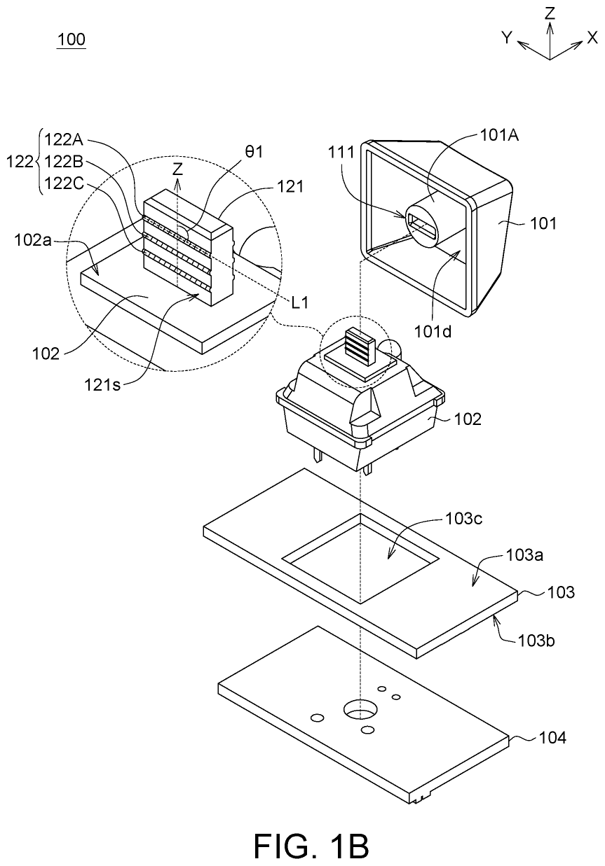

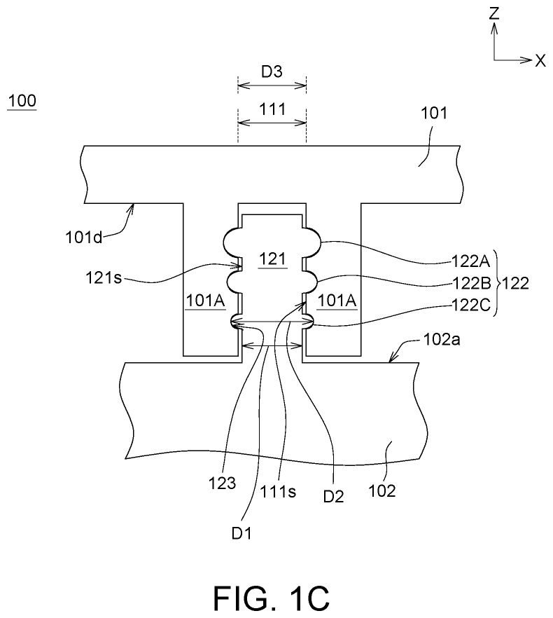

FIG. 1A is a 3D assembly diagram of a key structure 100 according to one embodiment of the disclosure; FIG. 1B is a 3D explosion diagram illustrating the key structure 100 of FIG. 1A; and FIG. 10 is a partial cross-sectional view of the key structure 100 taken along the tangent line S1 of FIG. 1A. In some embodiments of the disclosure, the key structure 100 can be adapted to a keyboard of an electronic device, such as a laptop or a desktop computer, to trigger a specific signal.

Refer to FIG. 1A, the key structure 100 includes a keycap 101, an actuator 102, a bottom plate 103 and a circuit board 104. The keycap 101 can be used in a horizontal bar key (such as the space key) or a key with normal size (such as a letter key). In the present embodiment, the keycap 101 is a normal size key.

The actuator 102 is disposed on the bottom plate 103 and coupled with the keycap 101. The bottom plate 103 includes a top surface 103a and a bottom surface 103b opposite to the top surface 103a. Besides, the bottom plate 103 further includes a receiving hole 103c, which passes through the top surface 103a and the bottom surface 103b and enables the actuator 102 to be disposed in the bottom plate 103.

In some embodiments of the disclosure, the actuator 102, which can be a mechanical switch, includes at least one elastic force element, such as (but not limited to) a spring (not shown), configured to provide an elastic force, which enables the keycap 101 to movably reciprocate along the Z-axis direction (also referred as an actuating direction) after the actuator 102 and the keycap 101 are coupled together. In detail, when the user presses the keycap 101, the keycap 101 moves towards the bottom plate 103 along the Z-axis direction. Meanwhile, the elastic force element of the actuator 102 provides the keycap 101 with a restore elastic force away from the bottom plate 103 along the Z-axis; when the user no more presses the keycap 101, the restore elastic force enables the keycap 101 to move to the original position before the keycap 101 is pressed from the bottom plate 103.

In some other embodiments of the disclosure, the actuator 102, which can be a plunger switch, which is inserted into a guide member (not shown) and adjacent to the two sides of the switch of the key structure 100. When the keycap 101 is driven by the switch, the actuator 102 moveably reciprocate along the Z-axis direction to guide and limit the keycap 101 to movably reciprocate within a specific range along the Z-axis direction.

The actuator 102 may include pins (not shown). When the actuator 102 is disposed on the bottom plate 103, the pins can be inserted on the circuit board 104 and fixed by tin solder to electrically connect to the circuit board 104. When the keycap 101 is moved to the pressed position from the un-pressed position, the actuator 102 can generate a trigger signal transmitting to the circuit board 104.

The keycap 101 includes a column 101A disposed on the bottom surface 101d of the keycap 101 and extending downward from the bottom surface 101d in the Z-axis direction. The column 101A has a slot 111. The top 102a of the actuator 102 may include a plug 121 extending upward from the top 102a of the actuator 102. The shape of the plug 121 corresponds to the slot 111, so that the plug 121 can be inserted and penetrated in the slot 111. The sidewall 121s of the plug 121 includes at least one protruding portion 122, which protrudes outward from the sidewall 121s perpendicular to the Z-axis direction. For example, the protruding portion 122 may be formed by a circular protrusion or a strip-shaped rib protruding from the sidewall 121s of the plug 121; and the hardness of the protruding portion 122 is substantially greater than the hardness of the inner wall 111s of the slot 111.

For example, in the present embodiment, the plug 121 is a rectangular cylindrical body; the shape of the slot 111 corresponds to the plug 121, and may be a rectangular groove. The protruding portion 122 includes a plurality of ribs (for example, ribs 122A, 122B, and 122C) protruding from the sidewall 121s of the plug 121. Moreover, each of the ribs 122A, 122B, and 122C has a long axis L1 forming an angle 81 with the Z axis direction that is not 180° (for example, 90°).

The width D1 of the plug 121 is smaller than (or equal to) the width D3 of the slot 111; the total width D2 of the ribs 122A, 122B, and 122C plus the width D1 of the plug 121 are greater than the width D3 of the slot 111. When the plug 121 is inserted into the slot 111, due to the difference in hardness, the ribs 122A, 122B, and 122C protruding from the sidewall 121s of the plug 121 may squeeze the inner wall 111s of the slot 111. Such that, a plurality of strip-shaped recesses 123 may be thus formed on the inner wall 111s of the slot 111 conformally engaged with the corresponding convex ribs 122A, 122B, and 122C respectively.

By the friction between the protruding portion 122 and the inner wall 111s of the slot 111, a proper interference fit can be provided, so that the actuator 102 and the keycap 101 can be tightly engaged with each other. It is no more necessary to insert a plug with a larger width dimension into a slot with a smaller width dimension for getting a tighter interference fit between the plug and the slot as in the prior art. Therefore, the risk of column 101A bursting due to the lateral squeezing force applied by the plug 121 can be effectively reduced, under the condition of achieving the same interference fit (in comparison with that of the prior art).

In some embodiments of the present disclosure, the ribs 122A, 122B, and 122C that have the farther distance away from the top 102a of the actuator 102 have higher protruding height. That is, the rib 122A that has the farthest distance away from the top 102a of the actuating member 102 has the highest protruding height, and the rib 122C that has the closest distance away from the top 102a has the smallest protruding height. When the plug 121 is inserted into the slot 111, the squeezing force applied by the rib 122C on the top of the column 101A (that is, the top of the slot 111 with poor expansion elasticity) can be reduced. The risk of the column 101A bursting can thus be further reduced.

However, the structure of the key structure 100 is not limited to this regard. For example, the cross-sectional shape of the plug 121 and the corresponding slot 111 (taken along the direction perpendicular to the Z-axis direction) is not limited to a rectangular shape. In some embodiments of the present disclosure, the cross-sectional shape of the plug 121 and the corresponding slot 111 (taken along the direction perpendicular to the Z-axis direction) may be circular, elliptical, arc, regular or irregular polygon. Alternatively, in some other embodiments of the present disclosure, the plug 121 can be disposed on the bottom surface 101d of the keycap 101; and the column with a slot may be correspondingly disposed on the top 102a of the actuator (not shown). In yet other embodiments, the protruding portions can be arranged on the inner wall of the slot. When the plug is inserted into the slot, the difference in hardness causes each protruding portion to squeeze the sidewall of the plug. And a plurality of strip-shaped recesses (not shown) may be formed on the sidewall of the plug.

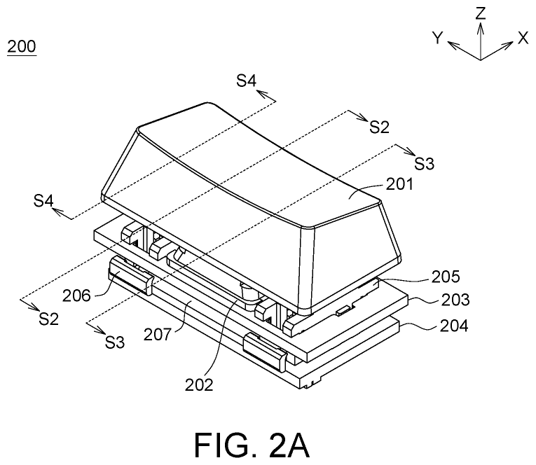

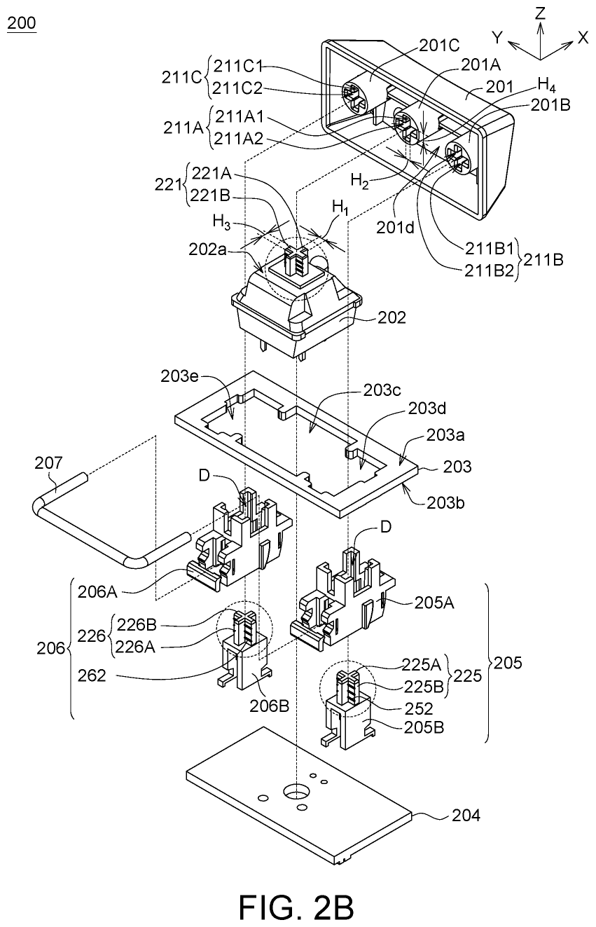

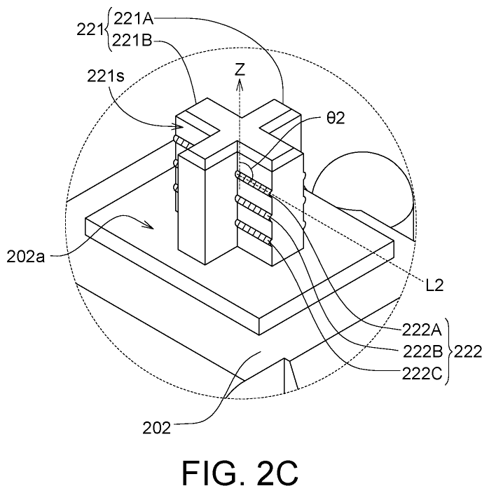

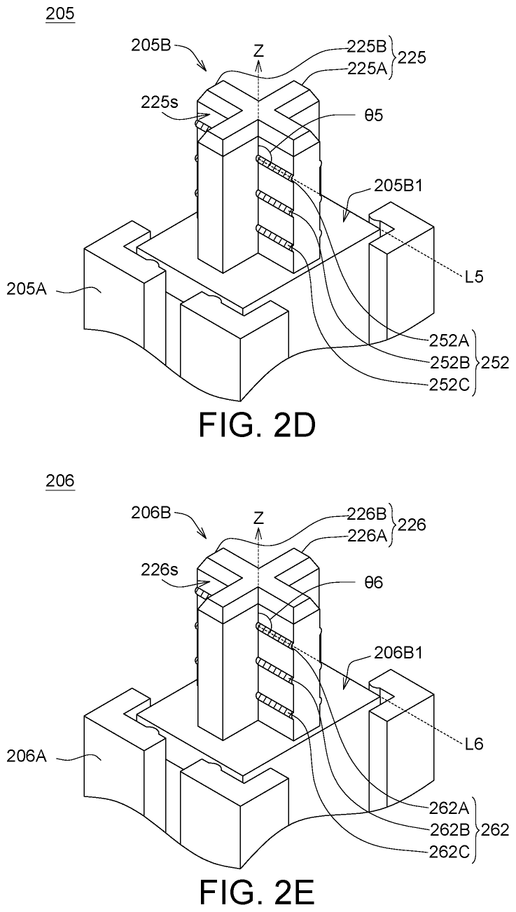

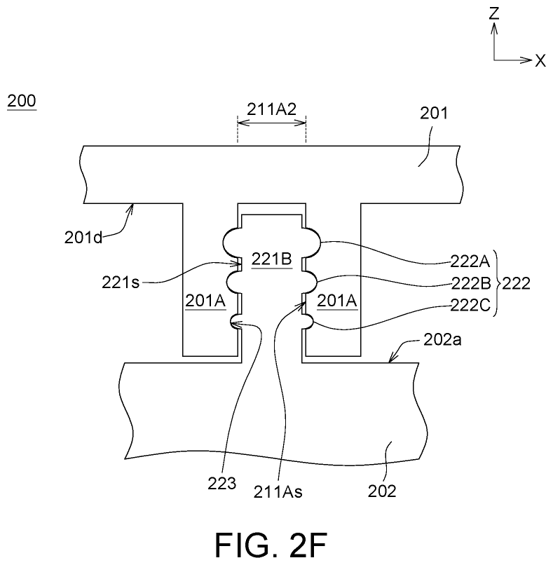

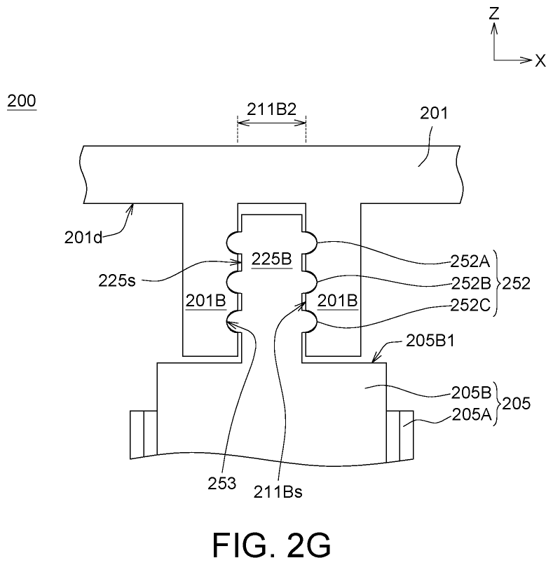

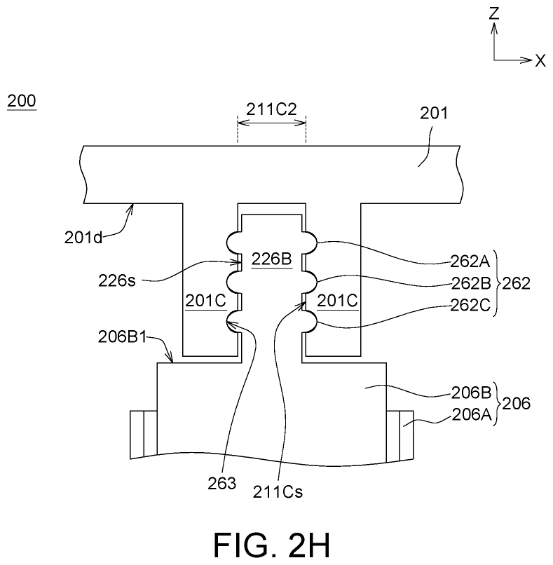

FIG. 2A is a 3D assembly diagram illustrating a key structure 200 according to another embodiment of the disclosure; FIG. 2B is a 3D explosion diagram illustrating the key structure 200 of FIG. 2A; FIG. 2C is an enlarged view illustrating a partial structure of a first actuator 202 as depicted in FIG. 2A; FIG. 2D is an enlarged view illustrating a partial structure of a second actuator 205 as depicted in FIG. 2A; FIG. 2E is an enlarged view illustrating a partial structure of a third actuator 206 as depicted in FIG. 2A; FIG. 2F is a partial cross-sectional view of the key structure 200 taken along the tangent line S2 of FIG. 2A; FIG. 2G is a partial cross-sectional view of the key structure 200 taken along the tangent line S3 of FIG. 2A; and FIG. 2H is a partial cross-sectional view of the key structure 200 taken along the tangent line S4 of FIG. 2A.

The structure of the key structure 200 is substantially similar to that of the key structure 100. The main difference is that the key structure 200 further includes a second actuator 205 and a third actuator 206; and each of the plugs 221, 225 and 226 respectively disposed on the first actuator 202, the second actuator 205 and the second actuator 206 has a cross-cylinder structure.

In the present embodiment, the key structure 200 includes a keycap 201, the first actuator 202, the second actuator 205, the third actuator 206, a bottom plate 203 and a circuit board 204. Wherein, the keycap 201 can be used in a horizontal bar key (such as the space key) including three columns 201A, 201B and 201C arranged on the bottom surface 201d of the keycap 201 and extending downward from the bottom surface 201d along the Z-axis direction. The columns 201A, 201B, and 201C respectively have slots 211A, 211B, and 211C.

The first actuator 202, the second actuator 205 and the third actuator 206 are respectively arranged on the bottom plate 203. The bottom plate 203 includes an upper surface 203a and a lower surface 203b opposite to the upper surface 203a. In addition, the bottom plate 203 also includes three adjacent holes 203c, 203d and 203e penetrating through the upper surface 203a and the lower surface 203b to allow the first actuator 202, the second actuator 205 and the third actuator 206 respectively accommodating therein.

The first actuator 202, the second actuator 205 and the third actuator 206 are engaged with the keycap 201. In some embodiments of the present disclosure, the first actuator 202 may be a mechanical switch, including at least one elastic element, such as a spring (not shown), to provide elastic force. After the first actuator 202 is engaged with the keycap 201, the keycap 201 can movably reciprocate along the Z-axis direction. The second actuator 205 and the third actuator 206 may be plunger switches respectively disposed adjacent to the two sides of the first actuator 202. When the keycap 201 is pressed by the user to drive the first actuator 202 to reciprocate along the Z-axis direction, it can guide and limit the keycap 201 to reciprocate along the Z-axis direction within a specific range.

In addition, the first actuator 202 may include two pins (not shown). When the first actuator 202 is disposed on the bottom plate 203, it can be inserted into the circuit board 204 and fixed by tin solder to electrically connect to the circuit board 204. When the keycap 201 is pressed to move from a non-pressed position to a pressed position, the first actuator 202 can generate a trigger signal and transmit it to the circuit board 204 to turn on the circuit.

In detail, the top 202a of the first actuator 202 includes a plug 221 extending upward from the top 202a of the first actuator 202. The shape of the plug 221 corresponds to the slot 211A, so that the plug 221 can be inserted and accommodating in the slot 211A. In the present embodiment, the plug 221 may be a cross-cylinder structure; it includes a first fin 221A and a second fin 221B that intersect each other, and extends upward in parallel to the Z-axis direction from the top 202a of the first actuator 202. The shape of the slot 211A corresponds to the plug 221, and may be a cross-shaped groove; it includes a first groove 211A1 and a second groove 211A2 that intersect each other, corresponding to the first fin 221A and the second fin 221B, respectively. The width H1 of the first fin 221A is greater than the width H2 of the first groove 211A1; the width H3 of the second fin 221B is less than or equal to the width H4 of the second groove 211A2.

The plug 221 further includes at least one protruding portion 222 protruding outward from the sidewall 221s of the second fin 221B perpendicular to the Z-axis direction. For example, the protruding portion 222 may be formed by a circular convex point or a strip-shaped rib protruding on the sidewall 221s of the second fin 221B; and the hardness of the protruding portion 222 is substantially greater than the hardness of the inner wall 211As of the second groove 211A2. In the present embodiment, the protruding portion 222 includes a plurality of ribs (for example, ribs 222A, 222B, and 222C) protruding from the sidewall 221s of the second fin 221B. Moreover, each of the ribs 222A, 222B, and 222C has a long axis L2 forming an angle 82 with the Z axis direction that is not 180° (for example, 90°).

When the plug 221 is inserted into the slot 211A, the first fin 221A and the first groove 211A1 can form a tightly interference fit by the squeezing force due to the width difference between these two; and the sidewalls of the second fins 221B and the second groove 211A2 are just in contact to, but not tightly squeezing with each other. Each of the ribs 222A, 222B, and 222C protruding from the sidewall 221s of the second fin 221B may squeeze the inner wall 211As of the second groove 211A2 due to the higher hardness, and a plurality of strip-shaped recesses 223 may be formed on the inner wall 211As of the second groove 211A2 and conformally engaged with the corresponding convex ribs 222A, 222B, and 222C.

The second actuator 205 and the third actuator 206 include guide parts 205A and 206A and movable parts 205B and 206B, respectively. The guide parts 205A and 206A are fixed on the bottom plate 203 through the holes 203d and 203e of the bottom plate 203, respectively. The movable parts 205B and 206B respectively pass through the guide holes D of the guide parts 205A and 206A, and are stopped and restricted within a certain range by the guide parts 205A and 206A, and movably reciprocate along the Z-axis direction. The key structure 200 may further include a balance bar 207. With the arrangement of the balance bar 207, the movable parts 205B and 206B can synchronously reciprocate in the guide parts 205A and 206A, which can prevent the keycap 201 from being skewed.

The top 205B1 of the movable part 205B may include a plug 225 corresponding to the slot 211B of the keycap 201 and engaged with each other. In the present embodiment, the plug 225 may be a cross-cylinder structure; it includes a third fin 225A and a fourth fin 225B that intersect each other, and extends upward parallel to the Z-axis direction from the top 205B1 of the movable part 205B. The shape of the slot 211B corresponds to that of the plug 225 and may be a cross-shaped groove; it includes a third groove 211B1 and a fourth groove 211B2 intersecting each other, corresponding to the third fin 225A and the fourth fin 225B, respectively. The third fin 225A has a width greater than that of the third groove 211B1; the fourth fin 225B has a width less than or equal to the width of the fourth groove 211B2.

The plug 225 further includes at least one protruding portion 252, which protrudes outward from the sidewall 225s of the fourth fin 225B perpendicular to the Z-axis direction. For example, the protruding portion 252 may be formed by a round convex point or a strip-shaped rib protruding from the sidewall 225s of the fourth fin 225B; and the hardness of the protruding portion 252 is substantially greater than that of the inner wall 211Bs of the fourth groove 211B2. In the present embodiment, the protruding portion 252 may be a plurality of ribs (for example, ribs 252A, 252B, and 252C) protruding from the sidewall 225s of the fourth fin 225B. Moreover, each of the ribs 252A, 252B, and 252C has a long axis L5 forming angle 85 with the Z axis direction that is not 180° (for example, 90°).

When the plug 225 is inserted into the slot 211B, the third fin 225A and the third groove 211B1 can form a tightly interference fit by the squeezing force due to the width difference between these two; and the sidewalls of the four fins 225B and the fourth groove 211B2 are just in contact to, but not tightly squeezing with each other. Each of the protruding ribs 252A, 252B, and 252C protruding from the sidewall 225s of the fourth fin 225B may squeeze the inner wall 211Bs of the fourth groove 211B2 due to the higher hardness; and a plurality of strip-shaped recesses 253 can be formed on the inner wall 211Bs of the fourth groove 211B2 and conformally engagement with the corresponding ribs 252A, 252B, and 252C, respectively.

The top 206B1 of the movable part 206B may include a plug 226 corresponding to the slot 211C of the keycap 201 and engaged with each other. In the present embodiment, the plug 226 may be a cross-cylinder structure; it includes a fifth fin 226A and a sixth fin 226B that intersect each other, and extends upward from the top 206B1 of the movable part 206B parallel to the Z-axis direction. The shape of the slot 211C corresponds to that of the plug 226 and may be a cross-shaped groove; it includes a fifth groove 211C1 and a sixth groove 211C2 that intersect each other, corresponding to the fifth fin 226A and the sixth fin 226B, respectively. The fifth fin 226A has a width greater than that of the fifth groove 211C1; the sixth fin 226B has a width less than or equal to the width of the sixth groove 211C2.

The plug 226 further includes at least one protruding portion 262, which protrudes outward from the sidewall 226s of the sixth fin 226B perpendicular to the Z-axis direction. For example, the protruding portion 262 may be formed by a circular convex point or a strip-shaped rib protruding from the sidewall 226s of the sixth fin 226B; and the hardness of the protruding portion 262 is substantially greater than that of the inner wall 211Cs of the sixth groove 211C2. In the present embodiment, the protruding portion 262 may be a plurality of protruding ribs (such as, protruding ribs 262A, 262B, and 262C) protruding from the sidewall 226s of the sixth fin 226B. Moreover, each of the ribs 262A, 262B, and 226C has a long axis L6 forming an angle 86 with the Z axis direction that is not 180° (for example, 90°).

When the plug 226 is inserted into the slot 211C, the fifth fin 226A and the fifth groove 211C1 can form a tightly interference fit by the squeezing force due to the width difference between these two; and the sidewalls of the sixth fin 226B and the sixth groove 211C2 are just in contact to, but not tightly squeezing with each other. Each of the protruding ribs 262A, 262B, and 262C protruding from the sidewall 226s of the sixth fin 226B may squeeze the inner wall 211Cs of the sixth groove 211C2 due to the higher hardness, and a plurality of strip-shaped recesses 263 can be form on the inner wall 211Cs of the sixth groove 211C2 and conformally engaged with the corresponding ribs 262A, 262B, and 262C.

By conformally engaging the protruding portions 222, 252, and 262 with the inner walls 211As, 211Bs, and 211Cs of the slots 211A, 211B, and 211C, respectively, proper interference fits can be provided, so that the first actuator 202, the second actuator 205 and the third actuator 206 are tightly combined with the slots 211A, 211B, and 211C, respectively. Therefore, the width dimensions of the first fin 221A, the third fin 225A, and the fifth fin 226A can be appropriately reduced to ease the squeezing force generated between the plugs 221, 225, and 226 and the corresponding slots 211A, 211B, and 211C, so as to moderate the lateral stress applied to the columns 201A, 201B, and 201C. Under the condition of achieving the same interference fit, in comparison with that of the prior art, the bursting risk of the columns 201A, 201B, and 201C can be effectively reduced.

According to aforementioned embodiments of the present disclosure, a key structure is provided. The key structure comprises a keycap and an actuator. The actuator is engaged with the keycap by a plug and a slot and enables the keycap to movably reciprocate along an actuating direction. At least one protruding portion protruding outward and perpendicular to the actuating direction is provided on the sidewall of one of the plug and the slot, and the hardness of the protruding portion is greater than the hardness of the sidewall of the other one of the plug and the slot. When the plug is inserted into the slot, the protruding portion squeezes the corresponding sidewall encountering the protruding portion and forms a recess on the corresponding sidewall to conformally engage with the protruding portion. Such that sufficient interference fit can be provided to make the actuator and the keycap tightly engaged.

By this approach, it is not necessary to additionally increase the difference in width dimension between the plug and the slot in order to form a tighter interference fit there between, and the lateral squeezing force applied by the plug to the sidewall of the slot can be greatly reduced. Thereby, the bursting risk of the keycap/switch due to excessive lateral squeezing force can be effectively reduced, on the premise of achieving a proper interference fit, when the slot and the plug are engaged. The processing yield of assembling the keycap and the switch as well as the quality of the key structure can be thus improved.

While the disclosure has been described by way of example and in terms of the preferred embodiment (s), it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A key structure, comprising:
a bottom plate,
a keycap; and
a first actuator, disposed on the bottom plate and engaged with the keycap to make the keycap movably reciprocating along an actuating direction perpendicular to the bottom plate;
wherein, one of the first actuator and the keycap has a first slot; the other one of the first actuator and the keycap has a first plug; the first plug is inserted in the first slot in parallel to the actuating direction; and one of the first slot and the first plug comprises at least one first protruding portion protruding perpendicularly to the actuating direction and conformally engaged with the other one of the first slot and the first plug.

2. The key structure according to claim 1, wherein the first plug comprises the at least one first protruding portion having a first hardness; the first slot has a sidewall with a second hardness; and the first hardness is greater than the second hardness.

3. The key structure according to claim 1, wherein the first slot comprises the at least one first protruding portion having a first hardness; the first plug has a sidewall with a second hardness; and the first hardness is greater than the second hardness.

4. The key structure according to claim 1, wherein the first plug protrudes from a first top of the first actuator; and the first slot is disposed in a first column protruding from a bottom surface of the keycap.

5. The key structure according to claim 4, wherein the at least one first protruding portion is at least one rib protruding perpendicular to the actuating direction outwards from a sidewall of the first plug and conformally engaged with a sidewall of the first slot; and the at least one rib has a long axis forming an angle with the actuating direction that is not 180°.

6. The key structure according to claim 4, wherein the first plug comprises a first fin and a second fin that intersect each other; the first top of the first actuator extends parallel to the actuating direction to form a cross-cylinder structure; the first slot is a cross-shaped groove comprising a first groove and a second groove intersecting each other and used for accommodating the first fin and the second fin respectively.

7. The key structure according to claim 6, wherein the first fin has a width greater than that of the first groove; the second fin has a width less than or equal to that of the second groove; the at least one first protruding portion is at least one rib protruding perpendicular to the actuating direction outwards from a sidewall of the second fin and conformally engaged with at least one recess formed on an inner wall of the second groove; and the at least one rib has a long axis forming an angle with the actuating direction that is not 180°.

8. The key structure according to claim 1, wherein the first plug protrudes from a bottom surface of the keycap; the first slot is disposed in a first column protruding from a first top of the first actuator.

9. The key structure according to claim 1, further comprising:
a second actuator, disposed on the bottom plate, adjacent to the first actuator, and together with the first actuator to make the keycap movably reciprocate along the actuating direction;
Wherein, one of the second actuator and the keycap has a second slot; and the other one of the second actuator and the keycap has a second plug inserted in the second slot parallel to the actuating direction; one of the second plug and the second slot comprises at least one second protruding portion protruding outward perpendicular to the actuating direction and conformally engaged with the other one of the second plug and the second slot.

10. The key structure according to claim 9, wherein the first actuator is a mechanical switch configured to provide an elastic force enabling the keycap to movably reciprocate along the actuating direction; and the second actuator is a plunger switch following the keycap to reciprocate along the actuating direction.
